(19) United States
(12) Patent Application Publication
(10) Pub. No.: US 2008/0291468 A1
(43) Pub. Date: Nov. 27, 2008

(54) Apparatus and method for measuring height of protuberances

(75) Inventors: Masanobu Sakata, Hitachinaka (JP); Hideo Ishimori, Nakai (JP); Tetsuyuki Ogawa, Hitachinaka (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION

(21) Appl. No.: 12/068,890

(22) Filed: Feb. 13, 2008

(30) Foreign Application Priority Data
Feb. 13, 2007 (JP) 2007-032450

(51) Int. Cl. G01B 11/02; G01B 11/24

(52) U.S. Cl. 356/612; 702/167

(57) ABSTRACT

The height of protuberances present on the surface of a product, typically a bump wafer, can be measured with a high accuracy irrespective of the state of the upper surfaces of the protuberances. In the signal processor of a bump height measuring apparatus, a bump height measurement area setting section set a bump height measurement area by the bump layout information, a statistical application section averages the height data in an statistical calculation within the measurement area, a contour line calculating section calculates a contour line of a section of the bump, and a bump height determining section determines a peak value in the contour line as the height of the bump.

### CLAIM OF PRIORITY

The present application claims priority from Japanese application serial No. 2007-32450, filed on Feb. 13, 2007, the content of which is hereby incorporated by reference into this application.

### BACKGROUND OF THE INVENTION

1. Field of the Invention

The present invention relates to an apparatus and method for measuring the height of protuberances formed on a product to be inspected.

2. Description of the Related Art

With the recent conspicuous tendency to the reduction in size of portable devices and the like and higher definition of display screens, the reduction of size and an increase in the number of pins are being made in quick tempo with respect to, for example, semiconductor chips for driving LCD which are mounted adjacently on a liquid crystal display panel. Against such inconveniences as short-circuit and defect of bumps resulting from the reduction in size and increase in the number of pins, total inspection of the bump shape is required to check the quality of bumps and ensure the reliability of chips in the semiconductor device wafer manufacturing stage. As an apparatus for measuring the height of a bump formed on a semiconductor wafer (bump wafer) there is known an apparatus which detects as a bump height a mean value of heights measured at various points of an area (bump upper surface) recognized as the bump as explained in Japanese Patent Laid-Open Publication No. Hei 11 (1999)-287722.

However, the shape of an upper surface of a bump is not limited to a flat plane. In a certain specification and manufacturing method for a bump wafer the bump upper surface is sometimes formed in a concave or convex shape even in a normal product. As the case may be, bumps having different shapes of upper surface are present on the one and the same chip.

Accordingly, it is an object of the present invention to provide an apparatus and method capable of measuring the height of protuberances present on the surface of a product to be inspected, typical of which are bumps on a bump wafer, with a high accuracy irrespective of the state of upper surfaces of the protuberances.

### SUMMARY OF THE INVENTION

According to the present invention, when the height of a protuberance present on the surface of a product to be inspected is to be measured, a protuberance height measurement area is calculated with respect to the to-be-measured protuberance on the basis of layout information of the protuberance present on the surface of the product to be inspected. Then, a contour line of a section of the protuberance is statistically calculated on the basis of measured heights of coordinate positions in the protuberance height measurement area, and the height of the protuberance is determined precisely after grasping the contour line of the protuberance.

Accordingly, the height of a protuberance present on the surface of a product to be inspected, typical of which is a bump on a bump wafer, can be measured with a high accuracy irrespective of the state of the upper surface of the protuberance.

### BRIEF DESCRIPTION OF THE DRAWINGS

FIG. 1 is a plan view showing a schematic configuration of a height measuring apparatus according to an embodiment of the present invention;

FIG. 2 is a schematic perspective view of an optical unit provided in the height measuring apparatus of the embodiment;

FIG. 3 is a schematic perspective view of single chip on a bump wafer;

FIG. 4 is a block diagram showing the detail of the signal processor in FIG. 1.

FIG. 5 is a flow chart showing an entire processing procedure in wafer inspection of the embodiment;

FIG. 6 is a schematic diagram showing a wafer entire surface scanning procedure of the embodiment;

FIG. 7 is a flow chart showing a actual processing procedure of the wafer entire surface measuring process of the embodiment;

FIG. 8 is an schematic diagram showing the concept of a bump height measuring process of the embodiment;

FIG. 9 is a schematic diagram showing the concept of a bump height measurement area calculating process of the embodiment;

FIG. 10 is a schematic diagram showing the contents of a laterally long bump height measuring process of the embodiment;

FIG. 11 is a schematic diagram showing the contents of a vertically long bump height measuring process of the embodiment;

FIGS. 12A to 12C are schematic diagrams of bumps of various surface shapes in the present embodiment;

FIG. 13 illustrates one image example on the display;

FIG. 14 illustrates another image example on the display;

FIG. 15 illustrates a further image example on the display; and

FIG. 16 illustrates a still further image example on the display.

### DETAILED DESCRIPTION OF A PREFERRED EMBODIMENT

An embodiment of the present invention will be described below with reference to the drawings.

### (The Basic Structure of the Apparatus)

The present invention is applicable to the inspection of height of protuberances formed on a flat plate-like product to be inspected such as a semiconductor wafer, a glass substrate for flat display, or a printed circuit board. However, in the following embodiment, reference will be made to an example in which the inspected product is a semiconductor wafer and particularly a bump wafer with bumps formed on the surface thereof used in a semiconductor device manufacturing process. The term “bump” is particularly used for a protruding electrode in the technical field.

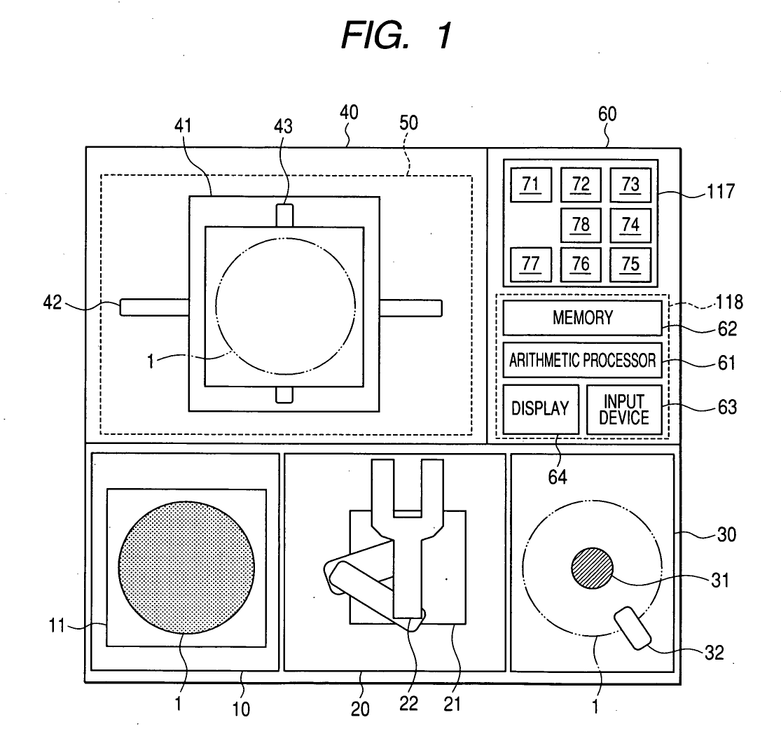

FIG. 1 is a plan view showing a schematic configuration of a height measuring apparatus according to an embodiment of the present invention.

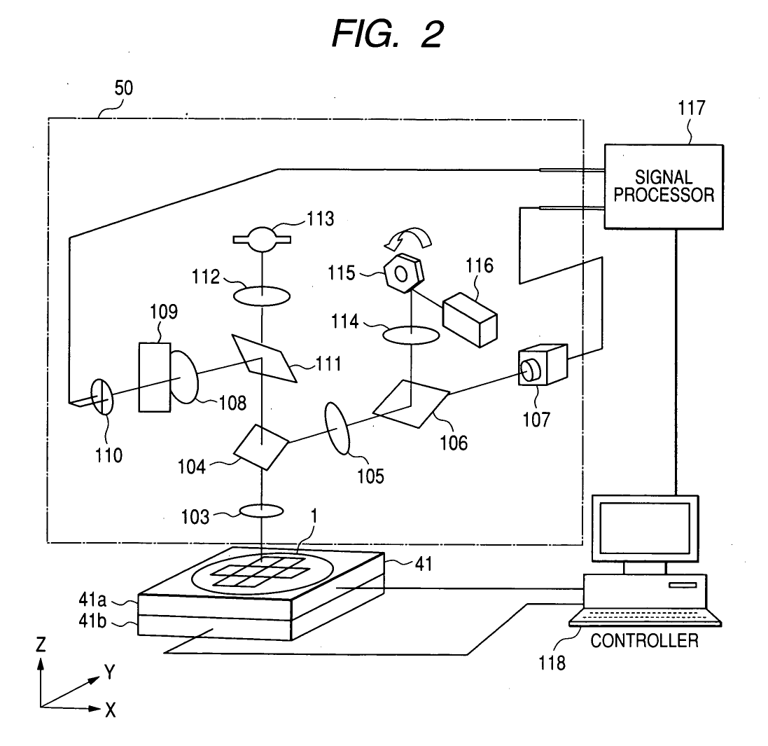

FIG. 2 is a schematic diagram showing a schematic configuration of the optical unit 50.

In FIG. 1, the height measuring apparatus illustrated in the figure includes a loading unit 10, a conveyance unit 20, a pre-alignment unit 30, an inspection unit 40, an optical unit 50, and a data processing unit 60. The optical unit 50 is disposed above the inspection unit 40. The data processing unit 60 includes a signal processor 117 and a controller 118.

A cassette 11 accommodating plural bump wafers 1 as products to be inspected and capable of being conveyed is placed on the loading unit 10.

The conveyance unit 20 is provided with a conveying device 21 for conveyance of a bump wafer 1. The conveying device 21 is driven in accordance with a command signal provided from the data processing unit 60 to hold the bump wafer 1 by a handling arm 22 and convey it among the cassette 11, pre-alignment unit 30 and inspection unit 40.

The pre-alignment unit 30 is provided with a support base 31 for placing the bump wafer 1 thereon and a sensor 32 for sensing an outer edge portion of the bump wafer 1 placed on the support base 31. By detecting an outer edge portion of the bump wafer 1 with the sensor 32 under rotation of the support base 31, there is performed pre-alignment of the position (central position) of the bump wafer 1 and the position of a notch formed in the bump wafer 1.

In the inspection unit 40 is provided with an inspection table 41 for placing thereon the bump wafer 1 to be inspected. The inspection table 41 is provided with a rotating mechanism (θ axis), a lift mechanism (Z axis) and a mechanism (X axis, Y axis) adapted to move within a horizontal plane, whereby it is possible to effect position alignment (centering and notch position alignment) of the bump wafer 1, height adjustment of the inspection table 41 with respect to a focal position of irradiation light in the optical unit 50, and a whole surface inspection of the bump wafer 1 involving movement of the bump wafer in X-Y directions with respect to irradiation light.

The inspection table 41 consists of an upper plate 41a and a lower plate 41b. And an X-axis screw 42 extending in the transverse direction, i.e., X-axis direction is threadedly engaged with the lower plate 41b. While a Y-axis screw 43 extending in the orthogonal direction to the x-axis, i.e., Y-axis direction is threadedly engaged with the upper plate 41a. The upper plate 41a, together with the Y-axis screw 43, is mounted on the lower plate 41b. For moving the bump wafer 1 on the inspection table 41 in X-axis direction, the X-axis screw 42 is rotated to move the upper plate 41a and lower plate 41b. While for moving the bump wafer in Y-axis direction, the Y-axis screw 43 is rotated to move the upper plate 41a over the lower plate 41b.

In FIG. 1, the controller 118 includes an input device 63 which is, for example, a keyboard, a touch panel, or a mouse, a display 64 which is, for example, a CRT or a flat panel display, an arithmetic processor 61 for execution of various arithmetic operations, and a memory 62 for the storage of programs and coefficients necessary for arithmetic operations, as well as calculation results and values being calculated. In this embodiment the data processing unit 60 not only can control the operation of the whole of the height measuring apparatus but also can instruct and operate the setting of inspection conditions for the bump wafer 1 and the display of inspection results with use of the display 64 and the input device 63.

### (Image Measuring System and Height Measuring System)

In FIG. 2, the optical unit 50 includes an image measuring system and height measuring system. The image measuring system further consists of a first irradiation optical device and first detection optical device. And the height measuring system consists of a second irradiation optical device and second detection optical device.

In the first irradiation optical device of the image measuring system, first irradiation light as substantially incoherent light emitted from a lamp 113, e.g., a halogen lamp, as an irradiation light source is collimated by a collimator lens 112, then is converged by an objective lens 103 via half mirrors 111 and 104 and is radiated to the bump wafer 1.

In the first detection optical device, reflected light of the first irradiation light from the bump wafer 1 is incident on the a half mirror 104 via the objective lens 103 and the reflected light from the half mirror 104 enters an image camera 107 via a focusing lens 105 and a half mirror 106 for image measurement.

In the second irradiation optical device of the height measuring system, second irradiation light is provided as coherent light emitted from a laser 116, e.g., a visible laser light source. The light is reflected by a rotating polygon scanner 115, then passes through an F-θ lens 114 and converted into a scanning beam which reciprocates in a predetermined area in X-axis direction. Further, the scanning beam is incident on the half mirror 104 via the focusing lens 105 and the half mirror 106 for height measurement. and the second irradiation light reflected by the half mirror 104 is converged by the objective lens 103 and is radiated to the bump wafer 1. In this way, the second irradiation light in the second irradiation optical device is radiated to the bump wafer 1 as a scanning beam which reciprocates and oscillates in a small scanning area along the X-axis direction.

In the second detection optical device, reflected light of the second irradiation light from the bump wafer 1 is incident on a half mirror 111 via the half mirror 104 and reflected light from the half mirror 111 is incident on a bisplit sensor 110, which has two separated sensors, via a focusing lens 108 and a knife edge 109 for height measurement. The second irradiation light having passed through the focusing lens 108 is incident on the second bisplit sensor 110 in a one-side of light axis is shielded state by the knife edge 109. In this case, the amount of received light in each sensor of the bisplit sensor 110 varies depending on the position (height) in Z-axis direction of the surface of the bump wafer 1. So, the surface height of the bump wafer 1 can be measured on the basis of the change in the amount of received light in each sensor.

In fact, the image measuring system having the first optical irradiating system and the first optical detecting system concentrates the irradiating light on an optical axis through the objective lens 103 so that the image data of the surface of the bump wafer is obtained by the image camera 107.

And the height measuring system having the second optical irradiating system and the second optical detecting system concentrates the irradiated coherent light on an optical axis to detect the height data on the point same as the image data obtained by said image measuring system in the same timing with the image measuring system.

In the signal processor 117 there is performed a predetermined arithmetic processing on the basis of the image data inputted from the image camera 107 and the height data 703 inputted from the bisplit sensor 110.

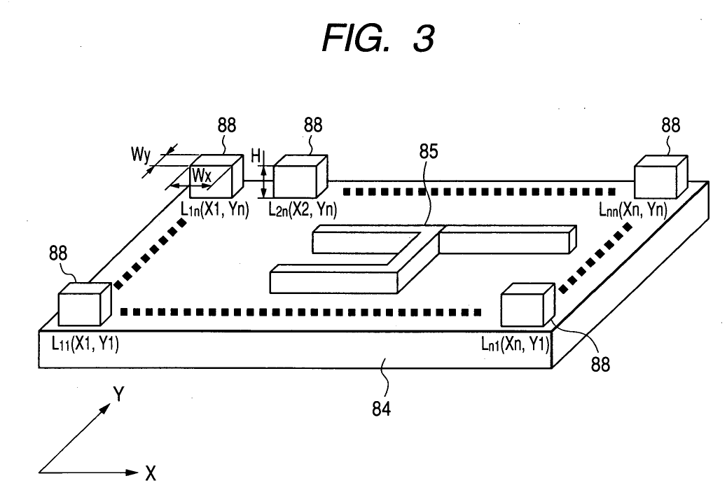

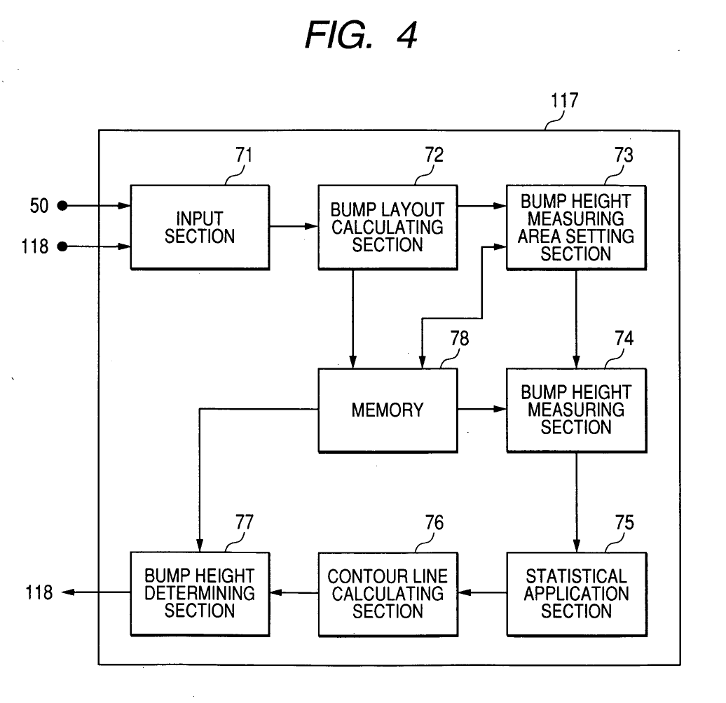

FIG. 3 is a schematic perspective view showing a configuration example of one of the plural chips on the bump wafer 1.

A circuit 85, other than bumps 88, is also formed on a chip 84 shown in FIG. 3. Plural such chips 84 with bump are arranged side by side in XY-axis directions on the bump wafer 1.

### (The Signal Processor)

As to the signal processor 117, in FIG. 1 to 3, during inspection of such a chip 84, there are detected an X-axis direction size Wx and a Y-axis direction size Wy of the upper surface of each bump 88. And as well as a fault of a bump position Lₙₙ (e.g., central coordinates of the bump) and a fault of the shape of the circuit 85 are detected. This process is done from a comparison with an new image data obtained from the image camera 107 and the image data of corresponding portions of adjacent chips already acquired. Further, from the height data acquired there is detected a height H of the bump 88 by a series of processes which will be described later.

The input section 71 is a block which receives signals from the optical unit 50 and the controller 118. Detection signals provided from the foregoing detection optical device in the optical unit 50 are also inputted to the signal processor 117 via the input section 71.

The bump layout calculating section 72 is a block which calculates layout information on each bump 88 in the chip 84 on the bump wafer 1 on the basis of detection signals inputted to the input section 71. The bump layout data calculated in the bump layout calculating section 72 is stored in a memory 78 disposed within the signal processor 117.

The bump height measurement area setting section 73 is a block which, on the basis of the bump layout information calculated in the bump layout calculating section 72, calculates a bump height measurement area wide in a first direction within a plane including the moving direction of the inspection table 41. The height of the bump 88 is evaluated by the measured height at each position in the area set by this bump height measurement area setting section 73.

The contour line calculating section 76 is a block which calculates a contour line of a section of the bump 88 taken in the first direction (for example, Y-axis direction). The contour line is calculated on the basis of statistical height values from the measurement points in the second direction (x-axis direction) within the bump height measurement area.

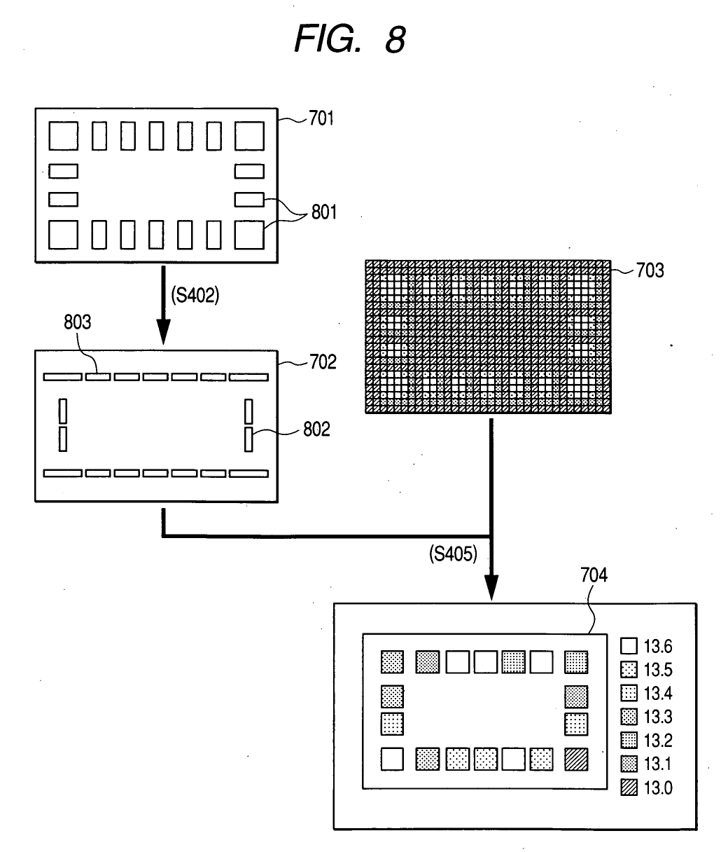

The bump height determining section 77 is a block which determines a value (e.g., a maximum value) evaluated from the bump contour line calculated by the contour line calculating section 76, as height data FIG. 8 on the bump concerned.

### (Wafer Inspection)

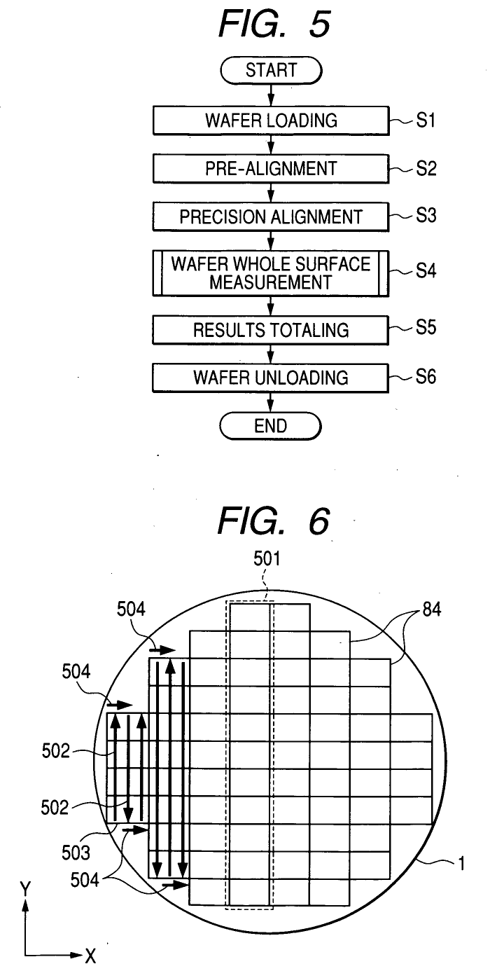

FIG. 5 is a flow chart showing an entire processing procedure of wafer inspection performed by the data processing unit 60.

In FIG. 5, in a wafer loading step (S1), a bump wafer 1 is carried out by the conveying device 21 from the cassette 11 placed on the loading unit 10 and is put on support base 31 in the pre-alignment unit 30. In a pre-alignment step (S2) which follows, there are performed pre-alignment for a positional error of the bump wafer 1 and notch position adjustment in the pre-alignment unit 30. The bump wafer 1 after the pre-alignment is again subjected to handling by the conveying device 21 and is placed and held on the inspection table 41 in the inspection unit 40. In a precision alignment step (S3), the positional error of the bump wafer 1 placed on the inspection table 41 is corrected alignmentwise by rotation and movement of the inspection table 41 and the height of the bump wafer 1 is adjusted with respect to a focal position by the lift mechanism in the inspection table 41.

In a wafer whole surface measuring step (S4), reflected light of the first irradiation light and reflected light of the second irradiation light from the bump wafer 1 are detected by the first and second detection optical devices, respectively, while emitting the first irradiation light and the second irradiation light from the optical unit 50 to acquire height data on the bump 88, from which there is obtained a height measurement value of the bump 88. At the same time, faults of size and position of the bump 88 and of the shape of the circuit 85 are detected for the whole surface of the bump wafer 1 from a comparison of image data between the chip 84 being measured and an adjacent chip.

In a results totaling step (S5), it is determined whether the height measurement value of each bump is good or bad and there is performed a statistical application of, for example, maximum value, minimum value, mean value and standard deviation with respect to the height measurement value for each chip 84. In addition, the good-bad determination result of the height measurement value on each bump and the fault information obtained in the wafer whole surface measuring step (S4) are totaled for each chip 84 to determine whether the chip is good or bad. The information obtained in the results totaling step (S5) is stored in the memory 62 (or in a memory not shown of the signal processor 117) and it can be read on the display 64.

In a wafer unloading step (S6), a command signal is outputted from the data processing unit 60 to the conveying device 21 and the bump wafer 1 after the measurement is conveyed to the original shelf stage in the cassette 11 by the conveying device 21. Then, the entire processing control procedure shown in FIG. 5 is over.

### (Measuring of Whole Wafer Surface)

FIG. 6 is a schematic diagram showing a scanning procedure for the whole wafer surface in the wafer whole surface measuring step (S4).

As shown in FIG. 6, chips 84 are arranged in X-Y directions on the bump wafer 1. Here, the chips 84 arranged in Y-axis direction are together designated a chip column 501. In scanning the whole surface of the bump wafer 1, first the lower left portion in FIG. 6 of the leftmost-side chip column 501 in the same figure on the bump wafer 1 is designated a measurement start position 503 and the inspection table 41 is moved by turning the X-axis screw 42 and the Y-axis screw 43 so that the measurement start position 503 becomes coincident with the irradiation light radiating position in the optical unit 50.

Next, height data and image data are acquired while moving the inspection table 41 in Y-axis direction by turning the Y-axis screw 43. In this embodiment, such a movement in Y-axis direction of the inspection table 41 to acquire data is designated Y-axis direction scan 502.

In this embodiment, the oscillating and vibrating scan area of the coherent light to the X-axis direction is rather small. Accordingly, when the overall width of the chip column 501 being measured cannot be scanned by a single Y-axis direction scan 502, the inspection table is moved up to the next scanning position by turning the X-axis screw 42 without acquiring data from the preceding Y-axis direction scan 502. In this embodiment this is designated an X-axis direction step movement 504. Thereafter, the Y-axis direction scan 502 and the X-axis direction step movement 504 are repeated until the scanning of the whole surface of the chip column 501 being measured is completed.

When the scanning of the whole surface of one chip column 501 is over, a shift is made to scanning of the chip column 501 adjacent on the right side to the scanned chip in FIG. 6 and the Y-axis direction scan 502 and the X-axis direction step movement 504 are repeated. In this way adjacent chip columns 501 are scanned, whereby the scanning of the whole surface of the wafer is executed and completed.

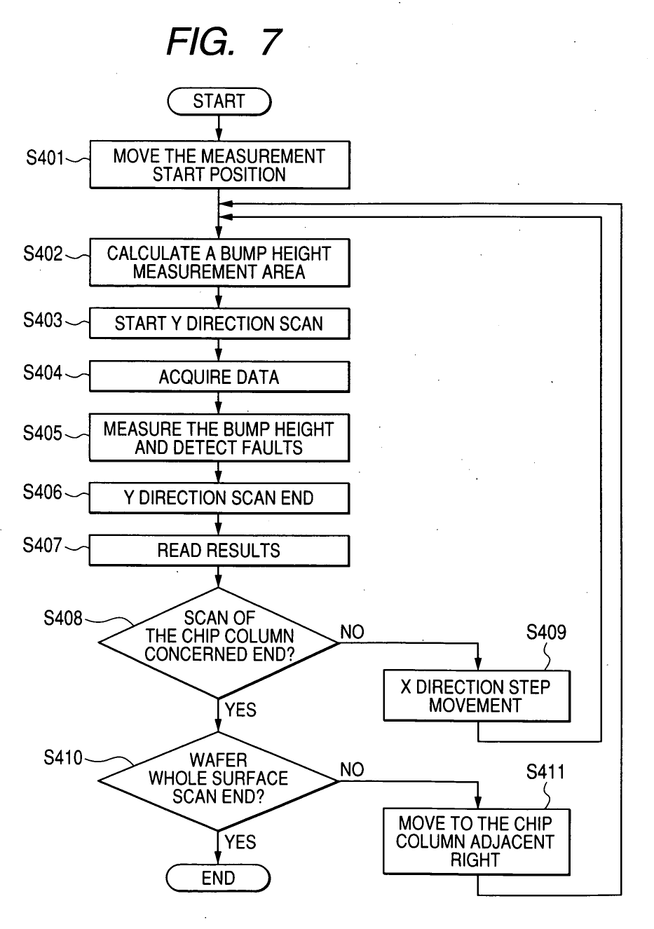

FIG. 7 is a flow chart showing a actual processing procedure of the wafer whole surface measuring step (S4) performed by the data processing unit 60. FIG. 8 is a schematic diagram of bump height measuring process.

In FIG. 7, the basic measuring step consists of following 7 steps.

S401: Move the measurement start position

S402: Calculate a bump height measurement area

S403: Start Y direction scan

S404: Acquire data

S405: Measure the bump height and detect faults

S406: Y direction scan end

S407: Read results

In FIG. 7, first in a measurement start position moving step (S401), the data processing unit 60 causes the inspection table 41 to move so that the measurement start position 503 of the bump wafer 1 becomes coincident with the irradiation light radiating position in the optical unit 50.

In the following bump height measurement area calculating step (S402), bump height measurement area data 702 is calculated from single chip bump map data 701 shown in the schematic diagram of FIG. 8 by the bump height measurement area setting section 73. The single chip bump map data 701 shown in FIG. 8 is calculated beforehand by the bump layout calculating section 72 on the basis of detected values in preview inspection for one to several chips which is conducted in advance of the main processing (S402), and is then stored in the memory 78 of the signal processor 117. In the case where inspection of the same type of bump wafers 1 is continued, the single chip bump map data 701 obtained can be utilized in later inspection.

In the processing (S402), of the single chip bump map data 701, the portion to be scanned in the Y-axis direction scan 502 which is executed in the subsequent step (S403) is read out by the bump height measurement area setting section 73 and a bump height measurement area is set by a predetermined arithmetic processing on the basis of the read information. The bump height measurement area setting section 73 stores the bump height measurement area data 702 of the Y-axis direction scan 502 portion thus obtained this time into the memory 78 of the signal processor 117.

Subsequently, in a Y-axis direction scan starting step (S403) and a data acquiring step (S404), while the Y-axis direction scan 502 is executed by turning the Y-axis screw 43, the bump height measurement area data 702 is read from the memory 78 by the bump height measuring section 74, a detection signal of the area corresponding to the bump height measurement area data 702 is inputted from the optical unit 50 via the input section 71 and both surface height data and image data of the bump wafer 1 at the portion of the Y-axis direction scan 502 are acquired.

In a bump height measuring and fault detecting step (S405), the height data and image date obtained in the data acquiring step (S404) are processed by the statistical application section 75, the contour line calculating section 76 and bump height determining section 77 to prepare a sectional contour line of each bump 88 and a height measurement value of the bump 88 is calculated. At the same time, faults in the size (XY size) and position (coordinates) of the bump 88 and in the shape of the circuit 85 are detected in comparison with corresponding portions of an adjacent chip.

In a Y-axis direction scan terminating step (S406), the signal processor 117 waits for termination of the Y-axis direction scan 502 and, upon termination of the Y-axis direction scan 502, shifts to a results reading step (S407), in which it outputs the bump height measurement result 704 and the fault detection result obtained in the preceding step (S405) are outputted to the controller 118. In the controller 118, those input data from the signal processor 117 are stored in the memory 62.

Thereafter, the data processing unit 60 determines whether the whole surface scan of the chip column 501 having been subjected this time to the Y-axis direction scan 502 was completed or not (S408). If the answer is negative, the data processing unit 60 executes the step (S409) of X-axis direction step movement 504, then returns the procedure to the bump height measurement area calculating step (S402) and again carries out the steps (S402) to (S408).

If it is determined in step (S408) that the whole surface scan of the chip column 501 concerned has been completed, the procedure is shifted to step (S410), in which it is determined whether the whole surface scan of the bump wafer 1 has been completed or not. If it is determined in step (S410) that the whole surface scan of the bump wafer 1 has not been completed yet, the X-axis direction step movement 504 is executed for shift to the chip column adjacent on the right side (S411), then the procedure is returned to step (S402) and the steps (S402) to (S408) are again carried out. If it is determined in step (S410) that the whole surface scan of the wafer has been completed, the data processing unit 60 terminates the wafer whole surface measuring step (S4).

Upon end of the wafer whole surface measuring step (S4), in the controller 118, a display signal is produced by the arithmetic processor 61 on the basis of the data acquired in step (S405) and stored in the memory 62 and the inspection result is displayed on the display 64 in accordance with operation of the input device 63 and that of the display 64 (or automatically).

### (Height Measuring)

FIG. 8 is an schematic diagram showing the concept of the process executed in step (S405) by the signal processor 117. Next, the bump height measuring process is explained in detail by FIG. 8.

In FIG. 8, the single chip bump map data 701 is a collection of layout information 801 of at least one bump 88 present within the same chip and differs depending on the type of wafer. The single chip bump map data 701 is acquired in advance of the step (S403) by the bump layout calculating section 72. The single chip bump map data 701 is obtained for example by comparing the strength of a detection signal with a threshold value and making distinction between a bump portion and a non-bump portion on the basis of the result of a preview conducted on the inspection table 41. On this regard, no limitation is made to the preview on the inspection table 41.

There may be adopted a method wherein the result of inspection separately conducted beforehand by another inspection apparatus is inputted for example from the controller 118 and the single chip bump map data 701 is calculated on the basis of the inputted data. Single chip map data 701 calculated beforehand in another inspection apparatus may be inputted. Further, there may be adopted a method wherein design data (e.g., CAD data) on the bump wafer 1 is inputted from the controller 118 for example and the intra-chip bump map data 701 is calculated on the basis of the inputted data.

The bump height measurement area data 702 is a collection of data containing both or at least one of the laterally long bump height measurement area 802 and the vertically long bump height measurement area 803. In the bump height measurement area calculating step (S402), the bump height measurement area data 702 is calculated before the Y-axis direction scan 502 by the bump height measurement area setting section 73 on the basis of the single chip bump map data 701.

The bump height measurement result 704 is calculated in the bump height measurement step (S405) from the height data 703 and the bump height measurement area data 702 by the statistical application section 75, the contour line calculating section 76 and the bump height determining section 77.

### (Height Measuring Area)

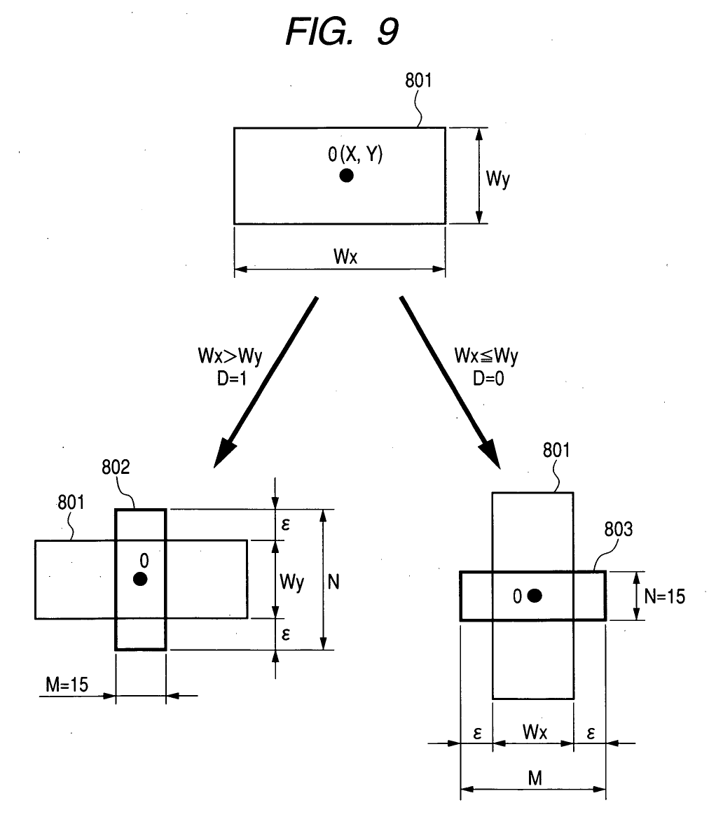

FIG. 9 is a schematic diagram showing the processing contents of the bump height measurement area calculating step (S402). Here, with reference to FIG. 9, the processing contents will be described while paying attention to one bump 88.

The single chip bump layout information 801 is an information piece which pays attention to one bump in the single chip bump map data 701, having the following information:
X: single chip X coordinates of a bump center O (unit: mm)
Y: single chip Y coordinates of the bump center O (unit: mm)
Wx: Size in X-axis direction of the bump (unit: μm)
Wy: Size in Y-axis direction of the bump (unit: μm)

The bump height measurement area 802 and the bump height measurement area 803 are the data which each pay attention to one bump in the bump height measurement area data 702, having the following information:
X′: single chip X coordinates of the bump center O (unit: sample)
Y′: single chip Y coordinates of the bump center O (unit: sample)
M: Size in X-axis direction of the bump height measurement area (unit: sample)
N: Size in Y-axis direction of the bump height measurement area (unit: sample)
D: Bump direction code
   (0: Vertically Long/1: Laterally Long)

By the “sample” as referred to herein is meant one element of height data 703 acquired in a lattice form. In case of representing the length in X-axis direction and that in Y-axis direction in terms of the sample, they are divided by a data acquisition pitch P (unit: μm) in X- and Y-axis directions of the height data 703. In this embodiment, for example, the size of one sample is assumed to be 2.5 μm×2.5 μm.

As to the bump direction (whether laterally long or vertically long), there is made classification on the basis of a relation between X-axis direction size Wx and Y-axis direction size Wy in the corresponding single chip bump layout information 801. In this embodiment, value “1” is given to D(D=1) in case of the corresponding single chip bump layout information 801 being laterally long (Wx>Wy), and the bump height measurement area 802 for a laterally long bump is calculated. At this time, the Y-axis direction size N of the bump height measurement area takes a value calculated by the following equation (Equation 1) which is established beforehand:

N=(Wy+2×ε)/P (Equation 1)
ε: positional error allowable distance (unit: μm)

It is preferable that the positional error allowable distance “ε” be set wider than a positional error quantity between the single chip bump layout information 801 and the height data 703 within the range not interfering with adjacent bumps in order that the bump height measurement area 802 may cover the data of actual overall width in Y-axis direction of the bump 88.

On the other hand, the size M in X-axis direction of the bump height measurement area, in case of D=1, can be set arbitrarily within the range smaller than the size of the data Wx in X-axis direction of the bump data, and as to the result of calculation of the bump contour line which will be performed later, the larger the value of M appropriately, the stabler the result. In this embodiment, the value of M is set at 15, for example, although it depends also on the arithmetic processing capability of the signal processor 117. As a result, the bump height measurement area 802 is set so as to cross the long side of the corresponding single chip bump layout information 801.

On the other hand, value “0” is given to D (D=0) in case of the single chip bump layout information 801 being vertically long (Wx<Wy) and in this case the bump height measurement area setting section 73 calculates the bump height measurement area 803 for a vertically long bump. In case of Wx=Xy, D may be set to 1 or 0, but in this embodiment D is set to 0 in case of Wx=Wy. Therefore, when Wx=Wy (D=0), the size M in X-axis direction of the bump height measurement area is calculated in accordance with the following equation (Equation 2) which is established beforehand:

M=(Wx+2×ε)/P (Equation 2)

On the other hand, the size N in Y-axis direction of the bump height measurement area, in case of D=0, can be set arbitrarily within the range smaller than the size of the data Wy in Y-axis direction of the bump data, and as to the result of calculation of the bump contour line which will be calculated later, the larger the value of N appropriately, the stabler the result. In this embodiment, N is set to, for example, 15 although this depends also on the arithmetic processing capability of the signal processor 117. As a result, the bump height measurement area 803 is also set so as to cross the long side of the corresponding single chip bump layout information 801.

Thus, the bump height measurement areas 802 and 803 include center coordinates of the bump to be measured and are each assumed to be a rectangular area which is narrower than the long-side size of the bump layout information data to be measured and wider than the short-side size of the bump data. Although in the example being considered the bump height measurement areas 802 and 803 are each assumed to be wider than the short-side size of the bump data to be measured, they each may be set at a size shorter than the short side by an amount corresponding to a narrower width than an assumed width of a bump convex portion.

### (Height Measurement of Laterally Long Bump)

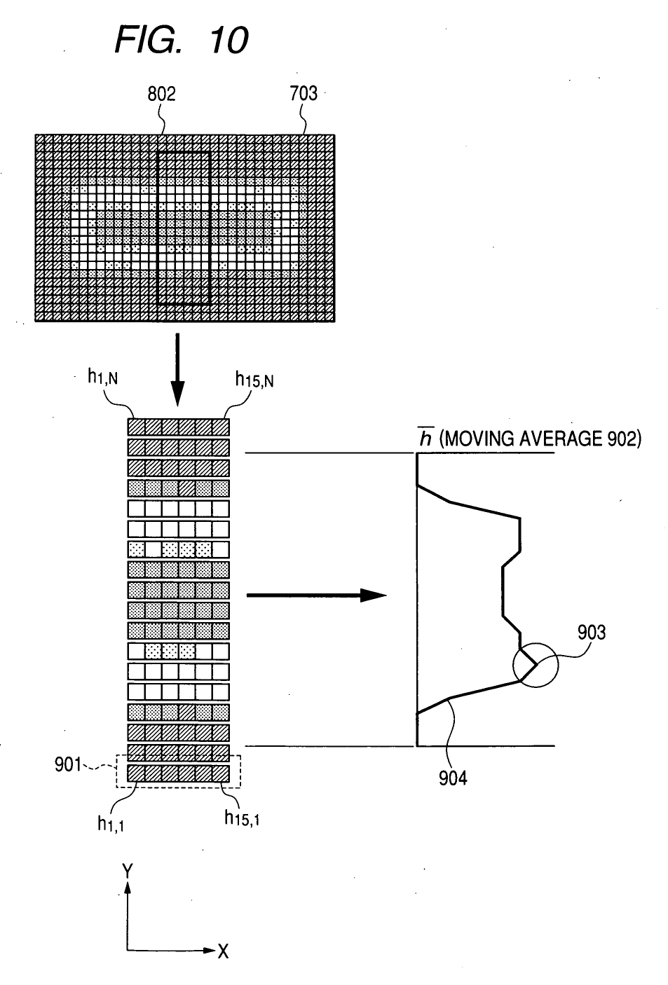

FIG. 10 is a schematic diagram showing the processing contents of a height measuring step (S405) of a laterally long (longer in X-axis direction size than in Y-axis direction size). Here, with reference to FIG. 10, the processing contents will be described while paying attention to one bump 88.

First, the statistical application section 75 extracts height data 703 falling under the range of the bump height measurement area 802 and divides the bump height measurement area 802 into a plurality of moving average calculation areas 901. One moving average calculation areas 901 consists of M (=15) samples in X-axis direction and one sample in Y-axis direction. That is, the bump height measurement area 802 can be regarded as being formed by N rows of moving average calculation areas 901 arranged in Y-axis direction (The number M is abbreviated to 6 in FIG. 10).

Next, the statistical application section 75 calculates a mean value of height data 703, i.e., a moving average value 902, within each moving average calculation area 901, as a statistical height value for calculating a bump contour line, in accordance with the following equation (Equation 3):

$$[ \begin{matrix}\overline{{h}_{N}} \\ ⋮ \\ \overline{{h}_{2}} \\ \overline{{h}_{1}}\end{matrix} ] = \frac{1}{15} [ \begin{matrix}{h}_{1 , N} & {h}_{2 , N} & ⋯ & {h}_{15 , N} \\ ⋮ & ⋮ & ⋮ & ⋮ \\ {h}_{1 , 2} & {h}_{2 , 2} & ⋯ & {h}_{15 , 2} \\ {h}_{1 , 1} & {h}_{2 , 1} & ⋯ & {h}_{15 , 1}\end{matrix} ] [ \begin{matrix}1 \\ ⋮ \\ 1 \\ 1\end{matrix} ] \qquad [ Equation 3 ]$$

In Equation 3, h_{1,1}˜h_{15,N} each stand for an element simplex of height data 703 in the bump height measurement area 802 and h̅₁˜ h̅_{N} each stand for an element of the moving average value 902.

In the contour line calculating section 76, a bump contour line 904 is calculated on the basis of the moving average value 902 thus calculated from a mean value of measurement heights at various positions in Y-axis direction within the bump height measurement area 802. The contour line 904 is obtained by plotting the moving average values 902 at various measurement points in Y-axis direction and it corresponds to an averaged bump section (e.g., a section obtained by plotting h₁, ₁˜h₁, _{N}) extending in Y-axis direction in terms of a value within the bump height measurement area 802.

Lastly, in the bump height determining section 77, a peak value (i.e., a maximum moving average value 902) in the contour line 904 is extracted as a height measurement value 903 of the bump to be measured and the height measurement value 903 is determined to be a measured height of the bump concerned. The results of calculation of the moving average value 902 and the bump height measurement value 903 can be displayed on the display 64.

### (Height Measurement of Vertically Long Bump)

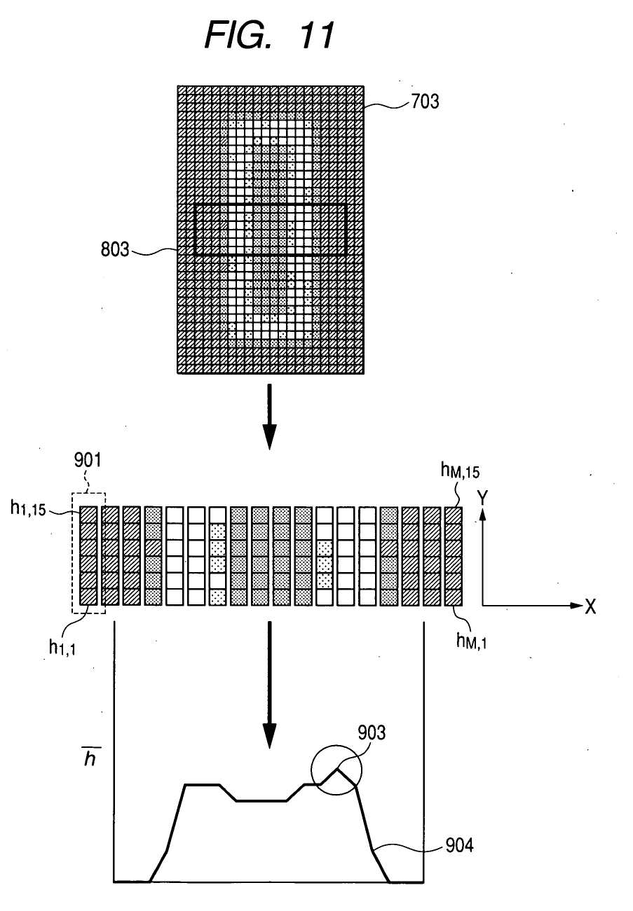

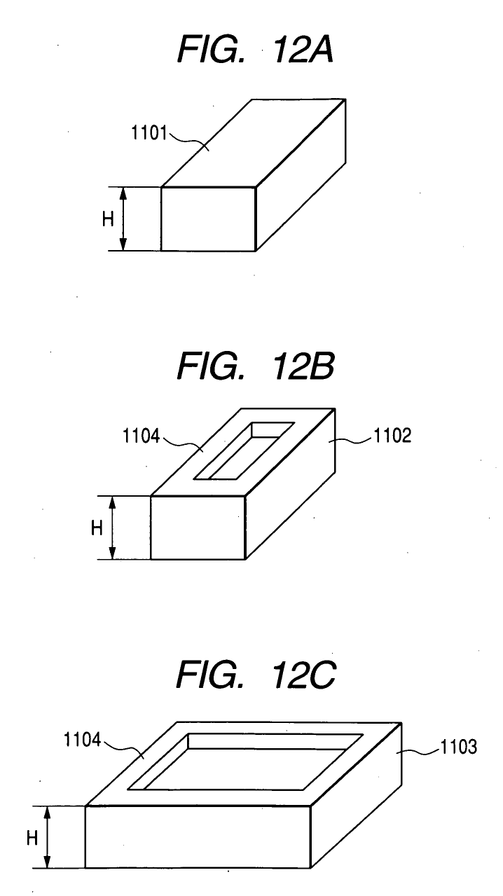

FIG. 11 is a conceptual diagram showing the processing contents of a height measuring step (S405) of a vertically long bump (longer in Y-axis direction size than X-axis direction size). Here, with reference to FIG. 11, the processing contents will be described while paying attention to one bump 88.

First, the statistical application section 75 extracts height data 703 falling under the range of the bump height measurement area 803 and divides the bump height measurement area 803 into moving average calculation areas 901 with one sample in X-axis direction and N (=15) samples in Y-axis direction. The bump height measurement area 803 can be regarded as being formed by M rows of moving average calculation areas 901 arranged in X-axis direction.

Next, the statistical application section 75 calculates a mean value of height data 703, i.e., a moving average value 902, within each moving average calculation area 901, as a statistical height value for calculating a bump contour line, in accordance with the following equation (Equation 4):

$$[ \begin{matrix}\overline{{h}_{1}} & \overline{{h}_{2}} & … & \overline{{h}_{M}}\end{matrix} ] = \frac{1}{15} [ \begin{matrix}1 & 1 & … & 1\end{matrix} ] [ \begin{matrix}{h}_{1 , 15} & {h}_{2 , 15} & … & {h}_{M , 15} \\ ⋮ & ⋮ & ⋮ & ⋮ \\ {h}_{1 , 2} & {h}_{2 , 2} & … & {h}_{M , 2} \\ {h}_{1 , 1} & {h}_{2 , 1} & … & {h}_{M , 1}\end{matrix} ] \qquad [ Equation 4 ]$$

In Equation 4, h_{1,1}˜h_{M,15} each stand for an element simplex of height data 703 in the bump height measurement area 803 and h̅₁˜ h̅_{M} each stand for an element of the moving average value 902.

In the contour line calculating section 76, a bump contour line 904 is calculated on the basis of the moving average value 902 thus calculated from a mean value of measurement heights at various positions in X-axis direction within the bump height measurement area 803. The contour line 904 is obtained by plotting the moving average values 902 at various measurement points in X-axis direction and it corresponds to an averaged bump section (e.g., a section obtained by plotting h₁, ₁˜h_{M, 1}) extending in X-axis direction in terms of a value within the bump height measurement area 803.

Lastly, in the bump height determining section 77, a peak value (i.e., a maximum moving average value 902) in the contour line 904 is extracted as a height measurement value 903 of the bump to be measured and the height measurement value 903 thus extracted is determined to be a measured height of the bump concerned. The results of calculation of the moving average value 902 and the bump height measurement value 903 can be displayed on the display 64.

According to this embodiment, since the bump height is evaluated after grasping the shape of a bump contour line on the basis of height measurement data of the bump height measurement area which crosses the bump upper surface, a bump height can be evaluated with a high accuracy with respect to not only a bump having a flat upper surface but also a bump whose upper surface includes concave and convex portions. The height of each of protuberances formed on the surface of a product to be inspected, typical of which are the bumps 88 on the bump wafer 1 shown in FIG. 3, can be measured with a high accuracy irrespective of the state of the upper surface of the protuberance.

In this connection, reference is here made to FIGS. 11A to 11C. It is possible to measure the height H of varied type of bumps with high accuracy. Even in the case a flat rectangular bump 1101, a rectangular bump 1102 having a great difference in length between the short side and the long side and having an elongated supper surface depression, and a generally square bump 1103 equal in the length of each side and having a relatively wide upper surface depression, are together present in one and the same chip.

In this embodiment, a peak value of the contour line 904 is adopted as a bump height measurement value in the processing performed by the bump height determining section 77. So in the rectangular and square bumps 1102, 1103 each having concave and convex portions the height of a convex portion (undepressed portion) 1104 formed along an outer edge portion of the upper surface is determined as the bump height.

In specifying the contour line 904, the results of measurement can be stabilized by calculating the moving average value 902 in comparison with calculating the bump height from the real height data on a specific straight line. The shape of the moving average calculation area 901 is not limited to 1×15 samples or 15×1 samples. When the upper surface shape of the product to be measured is assumed to be relatively flat like the bump 1101, the reproducibility of the moving average value 902 is generally improved by increasing the number of samples in the bump short side direction of the moving average calculation area 901 like for example 5×15 samples or 15×5 samples in the example being considered.

On the other hand, when the convex portion 1104 of a bump having concave and convex portions is narrow, by decreasing the number of samples in the bump short side direction of the moving average calculation area 901 as in this embodiment, the moving average value 902 become easier to follow variations of the height data 703 and the deviation of the bump height measurement result from the actual bump height is generally improved. The number of samples in the bump short side direction of the moving average calculation area 901 is preferably set such that the size in the bump short side direction of the moving average calculation area 901 is smaller than an assumed width of the convex portion 1104.

Although in this embodiment the X- and Y-axis directions are assumed to be first and second directions, respectively, this may be reversed. That is, there may be established a bump height measurement area which is wider than the long-side size of the bump 88 and narrower than the short-side size of the bump 88.

Moreover, in the processing performed by the bump height determining section 77 in this embodiment, a peak value of the contour line 904 is assumed to be the bump height measurement value 903 from the standpoint that the portion with which the bump first comes into contact as an electrode is extracted. However, where required, a mean value of the moving average values 902 which form the contour line 904 may be used as a bump height evaluation value, or a lowest point of the concave-convex portion of the upper surface may be used as an evaluation value.

Although reference has been made above as an example to the case where the size N in Y-axis direction of the bump height measurement area 802 and the size M in X-axis direction of the bump height measurement area 803 are calculated by such pre-established arithmetic expressions as the foregoing Equations 1 and 2, no limitation is made thereto. For example, the sizes N and M may be inputted using the input device 63 or the display 64 (see FIG. 1) both described above.

In this embodiment, the knife edge device is applied to the bump height detection. in the second detection optical device for height detection.

Though the present invention is also applicable for example to a height measuring apparatus using a detection optical device based on a light sectioning method wherein irradiation light is radiated obliquely to a product to be inspected and a difference in position between reflected light from the surface of the product to be inspected and reflected light from a reference surface is detected to detect the height of a protuberance, or based on a confocal device wherein a focal height of irradiation light is changed and a focal height corresponding to a maximum luminance is detected as a surface height of a product to be inspected.

### (Display Image)

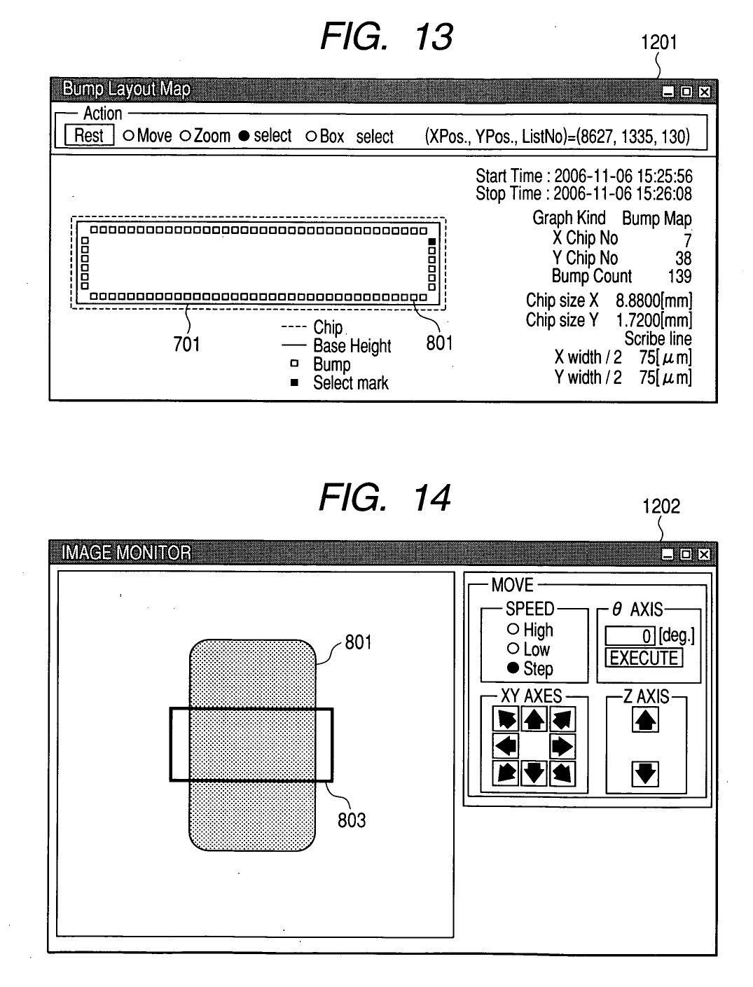

FIGS. 13 to 16 illustrate configuration examples of displays made on the display 64 shown in FIG. 1.

An single chip bump map data display 1201 shown in FIG. 13 is a display example of the single chip bump map data 701 shown in FIG. 8. In the single chip bump map data display 1201 reference can be made, for example, to button objects instructing expansion and contraction of display, parallel movement and selection of the single chip bump layout information 801, as well as single chip XY coordinates of a selected bump center, bump X width and bump Y width.

A bump height measurement area display 1202 shown in FIG. 14 is a display example of the bump height measurement area 803 shown in FIG. 9. This display is for wafer surface observation and provides a real-time display of a camera image. When the single chip bump layout information 801 is selected on the single chip bump map data display 1201, the inspection table 41 shown in FIG. 1 is positioned to the corresponding bump and each bump height measurement area 802 and each bump height measurement area 803 are displayed superimposedly on the camera image.

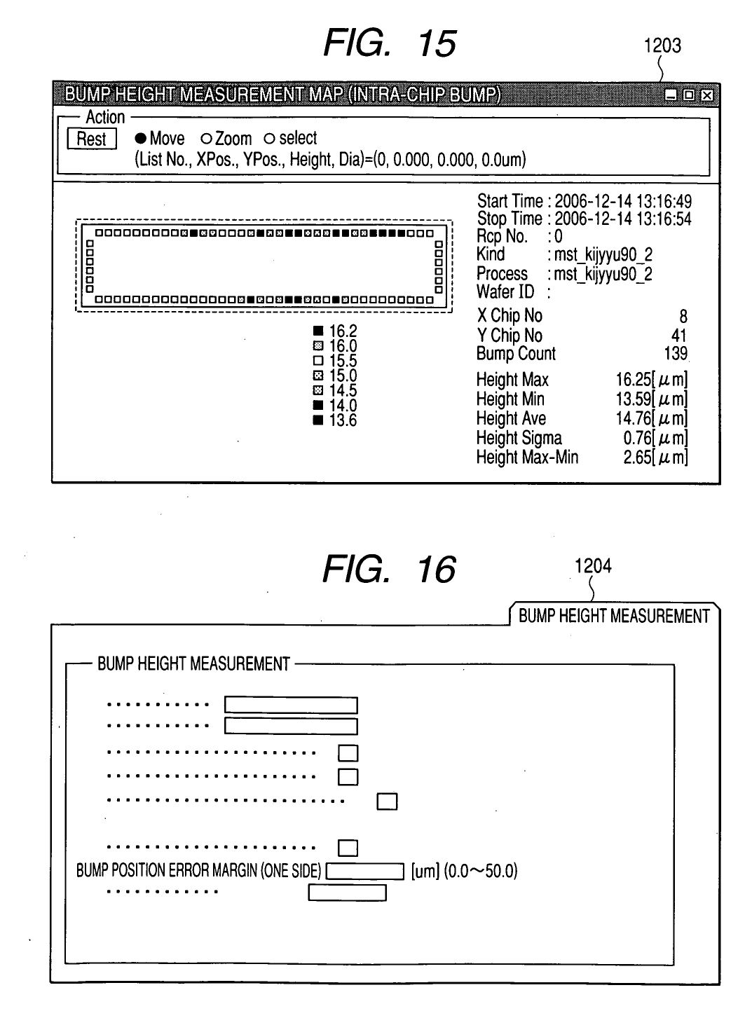

A bump height measurement result actual display 1203 shown in FIG. 15 is a display example of the bump height measurement result 704 shown in FIG. 8. The height of each bump is displayed in a distinctive manner using color and light and shade and various measurement values are displayed. Button objects instructing expansion and contraction of display and parallel movement are arranged within the display.

A positional error allowable distance setting display 1204 shown in FIG. 16 is a display for setting the positional error allowable distance e shown in FIG. 9. On the display, the value of the positional error allowable distance ε is inputted to the input item “Bump position error margin (one side).” For example, other parameters used in bump height measurement such as the size M in X-axis direction of the bump height measurement area 802 and the size N in Y-axis direction of the bump height measurement area 803 can also be set on this display.

What is claimed is:

1. An apparatus for measuring the height of a protuberance present on the surface of a product to be inspected, comprising:
an inspection table for placing thereon the product to be inspected;
an irradiation optical device for radiating irradiation light to the product to be inspected placed on the inspection table;
a detection optical device for detecting light reflected from the product to be inspected;
a measurement area setting section for setting a protuberance height measurement area in a first direction with respect to the protuberance to be measured present on the surface of the product to be inspected, on the basis of layout information on the protuberance;
a statistical application section for taking statistics of measurement heights and calculating a statistical height value in a second direction orthogonal to the first direction on the basis of measurement heights within the protuberance height measurement area set by the measurement area setting section;
a contour line calculating section for calculating a contour line of a section of the protuberance taken in the first direction on the basis of the statistical height value calculated by the statistical application section; and
a protuberance height determining section for determining as the height of the protuberance a value obtained from the contour line of the protuberance calculated by the contour line calculating section.

2. An apparatus according to claim 1, wherein the statistical application section calculates as the statistical height value a mean value taken in the second direction of the measurement heights.

3. An apparatus according to claim 1, wherein the protuberance height measurement area is assumed to be wide in the first direction with respect to the protuberance to be measured.

4. An apparatus according to claim 3, wherein the protuberance height measurement area is a rectangular area including center coordinates of the protuberance to be measured and assumed to be narrow in the second direction with respect to the protuberance.

5. An apparatus according to claim 1, wherein the protuberance height determining section determines a peak value within the contour line as the height of the protuberance to be measured.

6. An apparatus according to claim 1, wherein the product to be inspected is a bump wafer having bumps formed on the surface thereof, and the protuberance is any of the bumps on the bump wafer.

7. An apparatus for measuring the height of a protuberance present on the surface of a product to be inspected, comprising:
an inspection table for placing thereon the product to be inspected;
an irradiation optical device for radiating irradiation light to the product to be inspected placed on the inspection table;
a detection optical device for detecting light reflected from the product to be inspected;
a measurement area setting section for setting a protuberance height measurement area having a length calculated by a pre-determined arithmetic expression in a first direction with respect to the protuberance to be measured present on the surface of the product to be inspected, on the basis of layout information on the protuberance;
a statistical application section for taking statistics of measurement heights and calculating a statistical height value in a second direction orthogonal to the first direction on the basis of measurement heights within the protuberance height measurement area set by the measurement area setting section;
a contour line calculating section for calculating a contour line of a section of the protuberance taken in the first direction on the basis of the statistical height value calculated by the statistical application section; and
a protuberance height determining section for determining as the height of the protuberance a value obtained from the contour line of the protuberance calculated by the contour line calculating section.

8. An apparatus according to claim 7, wherein the statistical application section calculates as the statistical height value a mean value taken in the second direction of the measurement heights.

9. An apparatus according to claim 7, wherein the protuberance height measurement area is assumed to be wide in the first direction with respect to the protuberance to be measured.

10. An apparatus according to claim 9, wherein the protuberance height measurement area is a rectangular area including center coordinates of the protuberance to be measured and assumed to be narrow in the second direction with respect to the protuberance.

11. An apparatus according to claim 7, wherein the protuberance height determining section determines a peak value within the contour line as the height of the protuberance to be measured.

12. An apparatus according to claim 7, wherein the product to be inspected is a bump wafer having bumps formed on the surface thereof, and the protuberance is any of the bumps on the bump wafer.

13. An apparatus for measuring the height of a protuberance present on the surface of a product to be inspected, comprising:
an inspection table for placing thereon the product to be inspected;
an irradiation optical device for radiating irradiation light to the product to be inspected placed on the inspection table;
a detection optical device for detecting light reflected from the product to be inspected;
a measurement area setting section for setting a protuberance height measurement area having a length calculated by a pre-determined arithmetic expression in a first direction with respect to the protuberance to be measured present on the surface of the product to be inspected, on the basis of layout information on the protuberance;
a protuberance height measuring section for inputting the protuberance height measurement area set by the measurement area setting section and measuring the height of the surface of the product to be inspected present within the protuberance height measurement area;
a statistical application section for taking statistics of measurement heights and calculating a statistical height value in a second direction orthogonal to the first direction on the basis of measurement heights within the protuberance height measurement area obtained by the protuberance height measuring section;
a contour line calculating section for calculating a contour line of a section of the protuberance taken in the first direction on the basis of the statistical height value calculated by the statistical application section; and
a protuberance height determining section for determining as the height of the protuberance a value obtained from the contour line of the protuberance calculated by the contour line calculating section.

14. An apparatus according to claim 13, wherein the statistical application section calculates as the statistical height value a mean value taken in the second direction of the measurement heights.

15. An apparatus according to claim 13, wherein the protuberance height measurement area is assumed to be wide in the first direction with respect to the protuberance to be measured.

16. An apparatus according to claim 15, wherein the protuberance height measurement area is a rectangular area including center coordinates of the protuberance to be measured and assumed to be narrow in the second direction with respect to the protuberance.

17. An apparatus according to claim 13, wherein the protuberance height determining section determines a peak value within the contour line as the height of the protuberance to be measured.

18. An apparatus according to claim 13, wherein the product to be inspected is a bump wafer having bumps formed on the surface thereof, and the protuberance is any of the bumps on the bump wafer.

19. A method for measuring the height of a protuberance present on the surface of a product to be inspected, comprising:
setting a protuberance height measurement area in a first direction with respect to the protuberance to be measured present on the surface of the product to be inspected on the basis of layout information on the protuberance;
taking statistics of measurement heights and calculating a statistical height value in a second direction orthogonal to the first direction on the basis of measurement heights within the protuberance height measurement area;
calculating a contour line of a section of the protuberance taken in the first direction on the basis of the statistical height value; and
determining a value obtained from the contour line of the protuberance as the height of the protuberance.

20. A method for measuring the height of a protuberance present on the surface of a product to be inspected, comprising:
setting a protuberance height measurement area having a length calculated by a pre-determined arithmetic expression in a first direction with respect to the protuberance to be measured present on the product to be inspected on the basis of layout information on the protuberance;
taking statistics of measurement heights and calculating a statistical height value in a second direction orthogonal to the first direction on the basis of measurement heights within the protuberance height measurement area;
calculating a contour line of a section of the protuberance taken in the first direction on the basis of the statistical height value; and
determining a value obtained from the contour line of the protuberance as the height of the protuberance.

21. A method for measuring the height of a protuberance present on the surface of a product to be inspected, comprising:
setting a protuberance height measurement area having a length calculated by a pre-determined arithmetic expression in a first direction with respect to the protuberance to be measured present on the surface of the product to be inspected on the basis of layout information on the protuberance;
reading the protuberance height measurement area and measuring the height of the surface of the product to be inspected within the protuberance height measurement area;
taking statistics of measurement heights and calculating a statistical height value in a second direction orthogonal to the first direction on the basis of measurement heights within the protuberance height measurement area;
calculating a contour line of a section of the protuberance taken in the first direction on the basis of the statistical height value; and
determining a value obtained from the contour line of the protuberance as the height of the protuberance.
